(19) United States
(12) Patent Application Publication
(10) Pub. No.: US 2026/0054336 A1
(43) Pub. Date: Feb. 26, 2026

(54) FASTENING DEVICE FOR FIXING A STORAGE BODY TO A STORAGE DEVICE

(71) Applicant: Schwäbische Werkzeugmaschinen GmbH, Schramberg-Waldmössingen (DE)

(72) Inventors: Thomas FONTAINE, Niedereschach (DE); Damian MARMOL, Chelmiec (PL); Jianjun GAO, Suzhou (CN)

(21) Appl. No.: 19/307,590

(22) Filed: Aug. 22, 2025

(30) Foreign Application Priority Data
Aug. 24, 2024 (EP) 24196327.1

(51) Int. Cl. B23Q 1/00

(52) U.S. Cl. CPC B23Q 1/0072

(57) ABSTRACT

A fastening device having a storage surface and at least one retaining bolt protruding from the storage surface, at least one housing-like frame, including a cavity, which has a contact surface with which the frame means can be arranged in contact with the storage surface of the storage device and which includes a continuous recess on the side opposite the opening, by means of which a retaining bolt extending through the opening and arranged in the cavity of the frame means can be fixed in position relative to the frame means with at least one cover means, which is fixed to the frame means on the side of the frame means facing away from the opening and closes the recess and with at least one first guide unit, by means of which the fixing unit can be moved parallel to the contact surface in the cavity of the frame means.

### CROSS-REFERENCE

This application claims the benefit of European application EP 24196327.1 filed Aug. 24, 2024, which is incorporated herein by reference.

The invention relates to a fastening device for fixing a storage body to a storage device.

Fastening devices for fixing a storage body to a storage device are known from the state of the art in different variations. In these cases, a storage body, such as a component, workpiece or module, is deposited on a table-like or panel-like storage device and is fixed by the fastening device in relation to the storage device. The storage device has retaining bolts for this purpose, which are fixed onto the storage device and which protrude from a storage surface. In this case, the fastening device is placed on the retaining bolts and clamped to the retaining bolt using a fixing unit.

In the known fastening devices, the position at which the fastening device is fixed to the storage device on the protruding bolt is predetermined by the position of the retaining bolt. The arrangement of retaining bolts on the storage device is made possible on evenly, in particular grid-like, distributed recesses on the storage surface of the storage device. These recesses have a minimum distance to each other, which defines the placement options of the fastening devices.

In the known fastening devices, it has proven disadvantageous that the arrangement of fastening devices is defined by the positions of the retaining bolts and certain positions are not accessible by the fastening device on the storage surface.

### SUMMARY

One purpose of the embodiment of the invention is to propose a fastening device for fixing a storage body to a storage device, in which there are more options for positioning the fastening device.

This purpose is achieved by a fastening device for fixing a storage body to a storage device, which has a storage surface and at least one retaining bolt protruding from the storage surface, with at least one housing-like frame comprising a cavity that is accessible from the outside, and comprises a contact surface with which the frame on the storage surface of the storage device, and which comprises a continuous recess in the cavity on the opposite side of the frame, whereby the opening is accessible from the outside, with at least one fixing unit in the cavity through which a retaining bolt is attached relative to the frame cavity, with at least one cover that closes off the opening on the side facing away from the frame with at least an initial guiding unit between the cover and fixing unit and through which the fixing unit can be moved parallel to the contact surface in the cavity of the frame in an initial guiding direction.

As the fastening device comprises a fixing unit with which the fastening device can be fixed to a retaining bolt and the fixing unit within the fastening device is movable by the first guiding unit along a first guiding mechanism, the fastening device can be moved relative to the retaining bolt along the first guiding direction and thereby set in different positions with respect to the first guiding direction on the retaining bolt and thereby on the storage surface of the storage medium.

Thereby, the positions which can be occupied by the fastening device on the storage surface of the storage device are extended and the fixing of storage bodies improved by the improved adjustability of the fastening device.

As the frame comprises an opening, a retaining bolt on the storage device can be easily inserted through this to reach the fixing unit.

As the frame on the side facing away from the opening comprises a continuous recess, which is closed off by the cover, the fixing unit together with the cover can be easily positioned and fixed into or onto the frame.

The first guiding unit can be designed as desired, provided that it fulfils the technical function that the fixing unit relative to the cover is movable along the first guiding direction. In one embodiment of the fastening device, it is advantageous if the first guiding unit comprises at least one projection on the cover or fixing unit, which comprises an expanding cross-section transverse to the first guiding direction and which engages in a corresponding, in particular complementary, groove-like recess of the fixing unit or cover.

The at least one projection may in such a case be designed like a dovetail and the recess correspondingly comprises a dovetail-like cross-section.

The term “or” is not used as “or”, but in its original sense with the meaning “and in the other case”.

The guiding unit may comprise at least two projections and at least two recesses during further developments.

In order to leave the play between the projection and the recess as small as possible, it is advantageous if the first guiding unit comprises at least one clamping device, which is arranged between the cover and fixing unit and can be tensioned away from each other by the cover and fixing unit.

As a result, the projection and recess are moved toward each other in such a way that they always lie flat against each other.

In order to ensure the seamless movement of the fixing unit as a whole along the first guiding direction, it is advantageous if the fixing unit comprises a housing body on which the first guiding unit on the side facing the cover, in particular the groove-like recess or projection, is formed and the side facing away from the cover has a housing opening through which a housing cavity is accessible from the outside.

As the fixing unit comprises a housing body which has a housing opening on the side facing away from the cover, through which a housing cavity is accessible from the outside, a retaining bolt for holding in the fixed position can be inserted through the housing opening in order to be coupled with the fixing unit.

The housing body of the fixing unit has a smaller extension, i.e. smaller dimensions, in the direction parallel to the first guiding direction than the cavity of the frame. This allows a relative movement of the fixing unit, in particular of the housing body of the fixing unit, in the cavity of the frame along the first guiding direction.

In a further development of the latter embodiment, it is advantageous if the fixing unit comprises at least two clamping devices and at least one actuating means which can be actuated from outside the frame, which are arranged in the housing cavity of the housing body, wherein the at least two clamping devices along an actuating direction can be moved toward or away from each other relative to each other and from a fixed position in which the clamping device extends through the opening in the cavity of the retaining bolt on the frame, in a transverse movement relative to the actuating direction, in which the retaining bolt can be moved transversely or obliquely to the actuating direction.

As the fixing unit comprises two clamping devices, which can be moved along an actuating direction toward or away from each other relative to each other, fixing and releasing of the retaining bolt is made easier.

The actuating device can be operated manually by an operator or by a manipulator, such as a robot.

The relative movement between the at least two clamping devices can be realised arbitrarily, provided that the clamping device fulfils the function of keeping the retaining bolt in the fixed position against movement transverse to the actuating direction and by transferring it to the release position to move transversely or obliquely to the actuating direction.

In this case, the range of motion between two clamping devices may be at least 3 mm, in particular at least 5 mm, at least 10 mm.

In order to arrange the retaining bolt within the housing cavity and thereby with access to the at least two clamping devices, it is advantageous if the housing opening in the housing body comprises a cross-section tapering from the outside in the direction of clamping device, which comprises at its narrowest point at least a cross-section which is formed correspondingly, in particular complementarily, to the cross-section of the retaining bolt.

As a result, the housing opening forms a kind of inlet that centres the fixing unit with respect to the retaining bolt. This ensures secure gripping and fixing of the retaining bolt by means of at least two clamping devices.

In principle, it is conceivable that the retaining bolt is fixed by the at least two clamping devices. In addition, or alternatively, at least one of the at least two clamping devices may comprise a wedge-like clamping section, in particular in, obliquely or transversely to the actuating direction, which engages in the fixed position in a corresponding, in particular complementarily, formed rear grip portion of the retaining bolt and which puts tension on the retaining bolt when actuating in the actuating direction transversely to the actuating direction in the direction of the frame and forms a rear grip transversely to the actuating direction with the retaining bolt.

Due to the wedge-like clamping section in the actuating direction, when the two clamping devices of the retaining bolts are moved towards each other, the angle of the wedge-like clamping section can be pulled further toward the frame or increased contact force can be applied to the frame in the direction of the storage surface of the storage device. This means that the fixing unit simultaneously includes the function of clamping in the fixed position.

In order to ensure actuation of the actuating device either manually or by a manipulator, it is advantageous if the actuating device comprises an actuating element which protrudes in whole or at least in part in the direction parallel to the actuating direction from the frame through a hole in the frame and is fixed against moving parallel to the actuating direction and can be rotationally actuated from the outside about a parallel to the actuating direction and/or if the actuating means comprises a transmission element which is extended through the clamping device and by which a rotational movement of the actuating device can be converted into a translational movement.

As the actuating device with an actuating element protrudes from the frame, the actuating means is easily operable from the outside. As the actuating element is fixed against moving parallel to the actuating direction, it prevents the actuating element of the actuating device moving to a hard-to-reach location.

As the actuating device comprises a transmission element which is extended through the clamping devices and by which a rotational movement of the actuating element is convertible into a translational movement of the clamping device, the clamping devices can be moved toward or away from each other, either by manual or manipulated rotation of the actuating element by the translational movement which takes place parallel to the actuating direction.

The transmission element can be directly or indirectly attached to the clamping device.

The opening in the frame, through which the actuating device with the actuating element is extended, may be slot-shaped in order to enable movement of the fixing unit parallel to the first guiding direction.

In order to further improve the adjustability of the fastening device, in particular to arrange and set the fastening device on the storage surface of the storage device with more clearance, it is advantageous if the actuating device comprises a sliding element with which the actuating device can be moved parallel to the actuating direction relative to the actuating element and/or with which the clamping device can be moved relative to the actuating device, wherein the sliding element of the actuating device and the at least two clamping devices form a second guiding direction through the at least two clamping devices and can be moved parallel transversely to the actuating position in the housing body along a second guiding direction.

As the actuating device comprises a sliding element, the clamping device can be moved along a second guiding direction. The second guiding direction extends transversely to the first guiding direction and allows the at least two clamping devices to be moved within the housing cavity.

It proves advantageous if the sliding element transverse to the actuating direction comprises a polygonal cross-section, in particular a square, hexagonal or octagonal cross-section, and if the transmission element comprises an externally threaded portion and each clamping device an internally threaded portion acting together with the externally threaded portion.

If the sliding element transverse to the actuating direction comprises a polygonal cross-section, for example, rotational movements from the actuating element can be transferred to the transmission element via the sliding element. In such a case, the sliding element and the actuating element may comprise two separate or separable components and/or the sliding element and the transmission element may comprise two separate or separable components. The sliding element is thus extended through the actuating element or the transmission element through a correspondingly formed opening, whereby in a rotational movement this is transferred to the respective adjacent component and in a translational movement, the sliding element can slide parallel to the actuating direction without transmission of forces.

If the transmission element comprises an externally threaded portion and each clamping device comprises an internally threaded portion that acts together with the externally threaded portion, a rotational movement of the transmission element, for example by actuating the actuating element, can be converted into a translational movement of the clamping device, in particular parallel to the actuating direction.

In a further development of the latter embodiment, it is advantageous if the actuating element and the sliding element of the actuating device form a common single-piece component and/or if the sliding element and the at least one transmission element comprise separate or separable components from each other, wherein the sliding element has a sliding section comprising a polygonal cross-section in a corresponding, in particular complementary, continuous recess in the transmission element and is movable along the second guiding direction relative to the transmission element.

If the actuator and the sliding element of the actuator form a common single-piece component, the sliding element may be formed as a sliding section of this component and the actuator may be formed by an externally operable portion.

As the sliding element and the at least one transmission element comprise components separable from each other, the sliding element, in particular the common component, formed from the actuating element and sliding element, is arranged with the sliding element, in particular the sliding section, at least in sections arranged within the transmission element. The transmission element then comprises the externally threaded portion. Due to the polygonal cross-section of the sliding element arranged within the transmission element, a rotational movement on the actuating element is transferred to the transmission element and from there converted into a translational movement of the clamping device due to the external threaded portion.

Alternatively, or in addition to this, it may be that the actuating element and the sliding element of the actuating device comprise separate or separable components from each other, wherein the sliding element has a sliding section comprising a polygonal cross-section and can be arranged in a corresponding, in particular complementary, continuous recess in the actuating element and is movable along the second guiding direction relative to the actuating element and/or that the sliding element and at least one transmission element form a common component.

If the actuator and the sliding element of the actuator comprise separate or separable components from each other, the sliding element moves together with the clamping device when the clamping device is moved.

If the sliding element and the transmission element form a common single-piece component, the transmission element may be formed by a transmission section in which the common component comprises the externally threaded portion. The sliding element may be formed in the common component as a sliding section with the polygonal cross-section.

In order to overlap the side of the frame and cover, at least one panel-like wall element is provided in one embodiment of the fastening device, which is fixed onto the side of the frame comprising the opening and the cover, and which comprises a continuous wall opening which is aligned with the opening in the frame and which extends through the actuating element of the actuating device and is operable from the outside.

The continuous wall opening is particularly formed corresponding to the opening in the frame. Both can be slot-shaped and allow a relative movement of the fixing unit along the first guiding direction.

In a further development of the latter embodiment, the fastening device additionally comprises a bolt or screw-shaped alignment tool which is fixed in the cover which extends outwards in the wall opening or through the wall opening and by which a neutral position of the fixing unit can be set, and by a disc-shaped locking element through which the actuating element is extended through a corresponding, in particular complementary, locking element opening that conceals the wall opening of the wall element and the opening of the frame, and which floats and rotates around the alignment tool and enables movement of the actuating element along the first guiding direction.

By means of the alignment tool and locking element, that floats and rotates around the alignment tool, a neutral alignment of the fastening device can be set and the penetration of dirt or moisture into the housing cavity or into the cavity of the frame in the fastening device is at least minimised by the wall element. The floating storage of the wall element around the alignment tool can feature a rounded recess at the circumference of the wall element, for example.

Finally, it is advantageous if the wall element comprises at least one electronic element holder, in or on which an electronic element, such as a data carrier, sensor, chip, in particular an RFID chip, can be placed.

By means of the electronic element holder, a data carrier, sensor, chip, in particular RFID chip, can be specified on the fastening device. This allows the fastening device to be captured and managed.

Further features, details and advantages of the invention are apparent from the appended patent claims, from the diagrammatic representation and from the following description of preferred versions of the fastening device.

### BRIEF DESCRIPTION OF THE DRAWINGS

The drawing shows:

FIG. 1 A sectional side view of a first embodiment of the fastening device;

FIG. 2 A perspective, partial representation of a second embodiment of the fastening device;

FIG. 3 A detailed view of an area of the fixing unit of the second embodiment of the fastening device according to FIG. 2.

### DETAILED DESCRIPTION

The figures show two embodiments of a fastening device for fixing a storage body on a storage device 4, which is provided as reference 2.

The storage device 4 comprises a storage surface 6 and at least one holding bolt 8 projecting from the storage surface 6.

The fastening device 2 comprises a housing-like frame 10, which comprises a cavity 12, an opening 14 through which the cavity 12 is accessible from the outside, a contact surface 16 with which the frame 10 can be arranged in contact with the storage surface 6 of the storage device 4 and which comprises a continuous recess 18 on the opposite side of the opening 14.

In addition, the fastening device 2 comprises at least one fixing unit 20 arranged in the cavity 12 of the frame 10. Through the fixing unit 20, a holding bolt 8 of the storage device 4 extends through the opening 14, arranged in the cavity 12 of the frame 10, and can be fixed relative to the frame 10.

Further, the fastening device 2 comprises a cover 22, which is fixed to the side of the frame 10 facing away from the opening 14 on the frame 10. The recess 18 of the frame 10 is completely sealed off by the cover 22.

In addition, the fastening device 2 comprises a first guiding unit 24, which is formed between the cover 22 and the fixing unit 20. Through the first guiding unit 24, the fixing unit 20 can be moved along the first guide direction 26 relative to the cover 22 within the cavity 12 of the frame 10.

In the following, the common features of the fastening device 2 of the embodiments shown in the figures are described:

In the embodiments shown in the figures, the first guiding unit 24 comprises a projection 28 on the cover 22 and a corresponding, in particular complementary, groove-like recess 30 in the fixing unit 20. The projection 28 and recess 30 comprise a dovetail-like cross-section with respect to the first guiding direction 26.

In order to keep the projection 28 and the groove-like recess 30 of the first guiding unit 24 on surface contact at all times, the first guiding unit 24 comprises a clamping device 32, which is placed between the cover 22 and the fixing unit 20 and through which the cover 22 and the fixing unit 20 can be tensioned away from each other.

In the embodiments shown in the figures, the fixing unit 20 comprises a housing body 34, on whose side facing the cover 22, the first guiding unit 24, in particular the groove-like recess 30, is formed. On the side facing away from the cover 22, the housing body 34 comprises a housing opening 36, through which a housing cavity 38 is accessible from the outside.

In addition, the fixing unit 20 comprises two clamping devices 40 and at least one operable from outside the frame 10 using an actuating device 42. The clamping device 40 and the actuating device 42 are positioned at least in sections in the housing cavity 38, wherein the two clamping devices 40 along an actuating direction 44 to each other or away from each other relative to each other can be moved by the actuating device 42. In this case, the two clamping devices 40 from a fixed position, in which the clamping devices 40 extending through the opening 14, arranged in the cavity 4 of the frame 10 holding bolt 8 of the storage device 12 is fixed against a relative movement transverse to the operating direction 44, can be transferred to a release position in which the holding bolt 8 is released for moving transversely or obliquely to the actuating direction 44.

The actuating direction 44 runs parallel to the contact surface 16 of the frame 10 and transversely to the first guiding direction 26.

The clamping devices 40 each comprise, particularly in, obliquely or transversely to the actuating direction 44, a wedge-like clamping section 46, which engages in the fixed position in a correspondingly, in particular complementarily, formed rear grip section 48 of the holding bolt 8, and which clamps the holding bolt 8 when operating in the actuating direction 44 transversely to the actuating direction 44 in the direction of the frame 10. In the fixed position, the clamping section 46 and rear grip section 48 form a rear grip transversely to the actuating direction 44.

The actuating device 42 of the fixing unit 20 comprises an actuating element 50, which protrudes in whole or at least in part in the direction parallel to the actuating direction 10 through a hole 52 in the frame 10 from the frame 44 and is fixed against moving parallel to the actuating direction 44 and can be rotationally actuated from the outside about a rotational axis parallel to the actuating direction 44. In addition, the operating device 42 comprises a transmission element 54 which is extended through the clamping devices 40. Through the transmission element 54, a rotational movement of the actuating element 50 is convertible into a translational movement of the clamping devices 40.

In addition, the actuating device 42 comprises a sliding element 56. This comprises a polygonal cross-section.

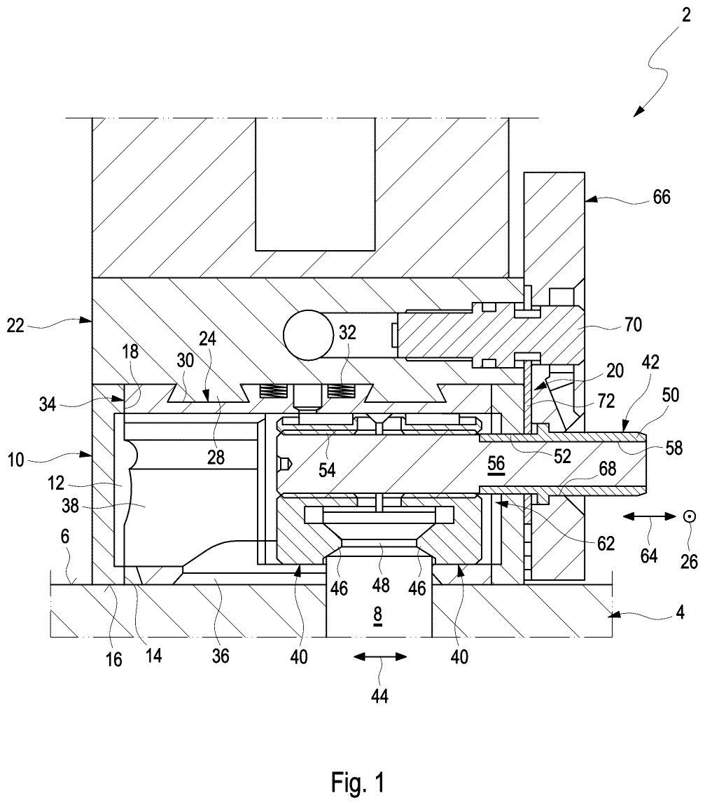

FIG. 1 shows a first embodiment of the fastening device 2, in which the transmission element 54 and the sliding element 56 form a common single-piece component. The transmission element 54 is formed by an externally threaded portion which interacts with the two clamping devices 40 together with a corresponding, in particular complementary, internally threaded portion.

The sliding element 56 is arranged within the actuating element 50. The sliding element 56 and actuating element 50 of the embodiment according to FIG. 1 are separate or separable components. The sliding element 56 is arranged in a correspondingly formed recess in the actuating element 50, whereby a rotational movement of the actuating element 50 is transferred to the sliding element 56 and leads to a rotational movement with the sliding element 56 of the transmission element 54. This rotational movement is converted by the transmission element 54 into a translational movement of the clamping devices 40 toward or away from each other with respect to the transmission direction 44.

Parallel to the transmission direction 44, the sliding element 56 in the embodiment according to FIG. 1 can slide within the recess 58 in the actuating element 50.

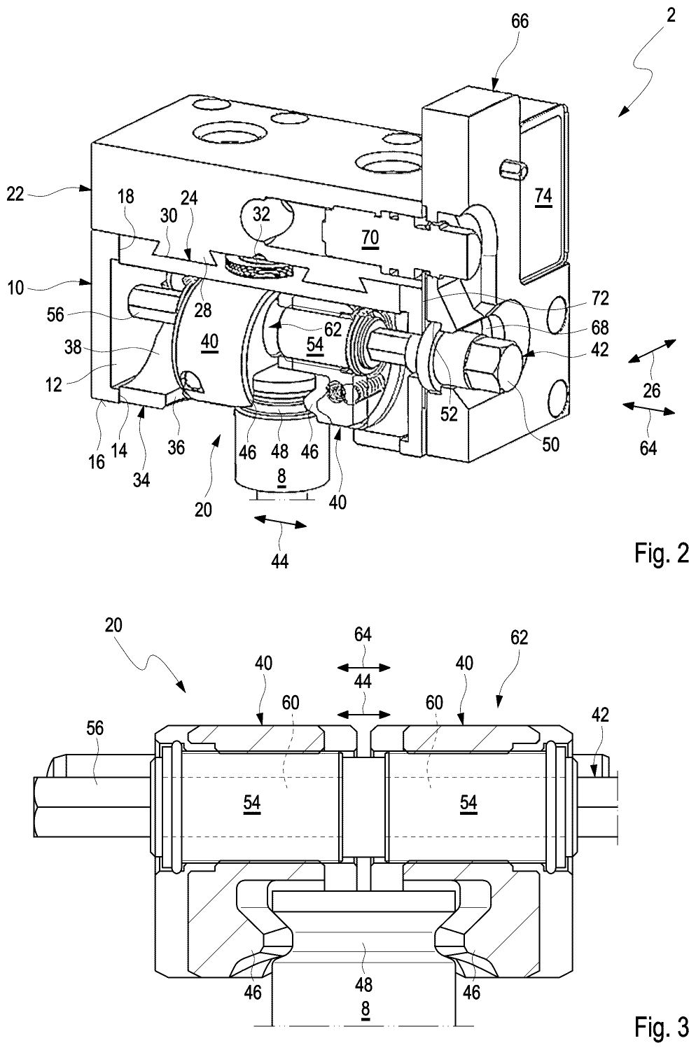

FIGS. 2 and 3 show a second embodiment of the fastening device 2, in which the operating element 50 and sliding element 56 are formed as a common single-piece component. The sliding element 56 and transmission element 54 comprise two separate or separable components. The sliding element 56 is arranged in a continuous recess 60 in the respective transmission elements 54. The transmission elements 54 comprise, in such a case, as separate or separable components, an externally threaded portion which is formed correspondingly, in particular complementarily to an internally threaded portion of the two clamping devices 40.

Both embodiments of FIGS. 1, 2 and 3 have in common that a second guiding unit 62 is formed between the sliding element 56 and the two clamping devices 40, through which the at least two clamping devices 40 can be moved at least in the release position parallel to the operating direction in the housing body 34 along a second guide direction 64.

In addition, both embodiments have in common that the fastening device 2 comprises a panel-like wall element 66 which is fixed to the opening 52 in the frame 10 on the frame 10 and on the cover 22 and which comprises a continuous wall opening 68 which is aligned with the opening 52 in the frame 10 and through which extends the actuating element 50 of the actuating device 42 and is operable from the outside.

In addition, the fastening device 2 comprises a bolt or screw-like alignment tool 70 which is fixed to the cover 22 which extends outwards in the wall opening 68 or through the wall opening 68 outwards and by which a neutral position of the fixing unit 20 can be set. In addition, a disc-shaped locking device 72 is positioned between the frame 10 and the cover 22 on the one hand and the wall element 66 on the other hand, by means of the actuating element 50 through a corresponding, in particular complementary, formed locking element opening, which completely covers the wall opening 68 of the wall element 66 and the opening 52 of the frame 10 and which is mounted to rotate about the alignment tool 70. The locking element 72 releases the actuating element 50 at least for moving along the first guide direction 26 within the opening 52 and the wall opening 68.

In addition, both embodiments of the fastening device 2 comprise an electronic element holder 74, in or on which an electronic element, such as data carrier, sensor, chip, in particular RFID chip, can be placed.

The features of the invention disclosed in the above description, in the claims and in the drawing may be essential for the realisation of the invention in its various embodiments, both individually and in any combination, within the scope of the following claims.

### REFERENCE SYMBOL LIST

2 Fastening device
4 Storage device
6 Storage surface
8 Retaining bolts
10 Frame
12 Cavity
14 Opening
16 Contact surface
18 Recess
20 Fixing unit
22 Cover
24 First guiding unit
26 First guiding direction
28 Projection
30 Recess
32 Clamping device
34 Housing body
36 Housing opening
38 Housing cavity
40 Clamping device
42 Actuating device
44 Actuating direction
46 Clamping section
48 Rear grip section
50 Actuating element
52 Opening
54 Transmission element
56 Sliding element
58 Recess in the actuating element
60 Recess in the transmission element
62 Second guiding unit
64 Second guiding direction
66 Wall element
68 Wall opening
70 Alignment tool
72 Locking element
74 Electronic element holder

1. A fastening device for fixing a storage body to a storage device, comprising:
a storage surface and at least one retaining bolt protruding from the storage surface,
at least one housing-like frame comprising a cavity which has an opening through which the cavity is accessible from the outside, which has an contact surface with which the frame means can be arranged in contact with the storage surface of the storage device, and which comprises, on the side opposite the opening, a continuous recess through which the cavity is accessible from the outside,
at least one fixing unit arranged in the cavity, by means of which a retaining bolt extending through the opening and arranged in the cavity of the frame means can be fixed in position relative to the frame means with at least one cover means, which is fixed to the frame means on the side of the frame means facing away from the opening and closes the recess and with at least one first guide unit, which is formed between the cover means and the fixing unit and by means of which the fixing unit can be moved parallel to the contact surface in the cavity of the frame means along a first guide direction.

2. The fastening device according to claim 1, wherein the first guiding unit comprises at least one projection on the cover or on the fixing unit, which comprises an expanding cross-section transverse to the first guiding direction and which engages in a corresponding, formed groove-like recess of the fixing unit or cover.

3. The fastening device according to claim 1, wherein the first guiding unit comprises at least one clamping device, which is arranged between the cover and fixing unit and can be tensioned away from each other by the cover and fixing unit.

4. The fastening device according to claim 1, wherein the fixing unit comprises a housing body, on whose side facing the cover the first guiding unit, the groove-like recess or the projection is formed and the side facing away from the cover has a housing opening through which a housing cavity is accessible from the outside.

5. The fastening device according to claim 4, wherein the fixing unit comprises at least two clamping devices and at least one actuating device which can be actuated from outside the frame, which are arranged in the housing cavity of the housing body, wherein the at least two clamping means can be moved towards or away from one another relative to one another along an actuating direction by the actuating means and from a fixed position, in which the clamping means secure a retaining bolt of the storage device, which bolt extends through the opening and is arranged in the cavity of the frame means, against relative movement transversely to the actuating direction, and can be transferred into a release position in which the retaining bolt is released for movement transversely or diagonally to the actuating direction.

6. The fastening device according to claim 4, wherein the housing opening in the housing body comprises a cross-section tapering from the outside in the direction of the clamping device, which comprises at its narrowest point at least one cross-section which is formed correspondingly, to the cross-section of the retaining bolt.

7. The fastening device according to claim 4, wherein at least one of the at least two clamping devices may comprise a wedge-like clamping section, which engages in the fixed position in a corresponding, formed rear grip portion of the retaining bolt and which puts tension on the retaining bolt when actuating in the actuating direction transversely to the actuating direction in the direction of the frame and forms a rear grip with the retaining bolt transversely to the actuating direction.

8. The fastening device according to claim 4, wherein the actuating device comprises an actuating element which protrudes in whole or at least in part in the direction parallel to the actuating direction from the frame through a hole in the frame and is fixed against moving parallel to the actuating direction and can be rotationally actuated from the outside about a parallel to the actuating direction and/or if the actuating device comprises a transmission element which is extended through the clamping device and by which a rotational movement of the actuating element can be converted into a translational movement of the clamping device.

9. The fastening device according to claim 8, wherein the actuating device comprises a sliding element with which the actuating device can be moved parallel to the actuating direction relative to the actuating element and/or with which the clamping devices can be moved relative to the actuating device, wherein the sliding element of the actuating device and the at least two clamping devices form a second guiding direction through the at least two clamping devices and can be moved parallel transversely to the actuating position in the housing body along a second guiding direction.

10. The fastening device according to claim 9, wherein the sliding element transverse to the actuating direction comprises a polygonal cross-section, and if the transmission element comprises an externally threaded portion and each clamping device an internally threaded portion acting together with the externally threaded portion.

11. The fastening device according to claim 10, wherein the actuating element and the sliding element of the actuating device form a common single-piece component and/or if the sliding element and the at least one transmission element comprise separate or separable components from each other, wherein the sliding element has a sliding section comprising a polygonal cross-section in a corresponding, continuous recess in the transmission element and is movable along the second guiding direction relative to the transmission element.

12. The fastening device according to claim 10, wherein the actuating element and the sliding element of the actuating device comprise separate or separable components from each other, wherein the sliding element having a sliding section comprising a polygonal cross-section can be arranged in a corresponding, continuous recess in the actuating element and is movable along the second guiding direction relative to the actuating element and/or that the sliding element and at least one transmission element form a common component.

13. The fastening device according to claim 8, wherein a panel-like wall element which is fixed to the opening in the frame on the frame and on the cover and which comprises a continuous wall opening which is aligned with the opening in the frame and through which extends the actuating element of the actuating device and is operable from the outside.

14. The fastening device according to claim 13, wherein a bolt or screw-shaped alignment tool which is fixed in the cover which extends outwards in the wall opening or through the wall opening and by which a neutral position of the fixing unit can be set, and by a disc-shaped locking element through which the actuating element is extended through a corresponding, locking element opening that conceals the wall opening of the wall element and the opening of the frame, and which floats and rotates about the alignment tool and enables movement of the actuating element along the first guiding direction.

15. The fastening device according to claim 13, wherein the wall element comprises at least one electronic element holder, in or on which an electronic element can be placed.
